(19) United States
(12) Patent Application Publication
(10) Pub. No.: US 2008/0103945 A1
(43) Pub. Date: May 1, 2008

(54) SYSTEM AND METHOD FOR CONNECTING ENTERTAINMENT MEDIA SERVERS TO LOCAL VIDEO SHOP INVENTORIES

(76) Inventors: Robin Ross Cooper, La Mesa, CA (US); Thomas A. Munro, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/928,993

(22) Filed: Oct. 30, 2007

Related U.S. Application Data
(60) Provisional application No. 60/863,925, filed on Nov. 1, 2006.

(51) Int. Cl. G06Q 10/00; G06F 17/30; G06F 17/40; G06F 19/00

(52) U.S. Cl. 705/28

(57) ABSTRACT

A video shop access system allows consumers to receive information on title inventories available at local video shops in the consumers' geographical area through their home or wireless media servers. A video shop data center receives title information on inventory available at the local video shops and stores the title information in an inventory data base. On receipt of a request from a consumer's media server, a video shop user interface is provided to the media server and displayed on an associated user display device, the user interface providing a link to the stored title inventories. The consumer can select and order titles through the interface, and orders are forwarded by the data center to the appropriate local video shop, which delivers a physical copy of the title to the requesting consumer.

### RELATED APPLICATION

The present application claims the benefit of co-pending U.S. provisional patent application No. 60/863,925 filed Nov. 1, 2006, which is incorporated herein by reference in its entirety.

### BACKGROUND

1. Field of the Invention

The present invention relates to media distribution such as video content distribution, and is particularly concerned with a system and method for connecting entertainment media servers to local video shop inventories in order to provide consumers with access to title lists available at the video shops.

2. Related Art

It is well known that the video rental business has emerged as a powerful market for video content distribution offering the world's best title selections including big-budget Hollywood movies and television product. By offering consumers a choice between numerous titles that were in the theaters only a few months prior, it is possible to satisfy a large market demand profitably. Furthermore, the consumer can decide whether to purchase the title or simply rent the title on a per-night basis. Since the rental model is significantly lower in price than the purchase model, and since consumers typically watch a movie only once, the economics tend to suggest that the consumer rent rather than own.

In recent years this video rental business has come under attack. Although the new electronic distribution models are, for the most part, still on the horizon, it is clear that the video rental businesses are about to face a host of emerging competitive attacks. Some of these attacks are by way of new video-on-demand services offered by Pay-Television operators world-wide. Other attacks are from the new video delivery platforms and offerings, some over the web. Still others are arising from the world of mobile and wireless media delivery. All of these options offer numerous attractive titles with a few simple clicks of a remote control, mouse, keyboard, or dial-pad.

A key question to ask, however, is the effects of the media leaving the physical realm and entering the virtual realm. For example, consumers in the past would buy or rent digital video discs (DVDs) that they could take home and play. The same consumers are now exposed to services that no longer offer physical or tangible media that can be handled. Instead, consumers are offered a movie “play”. Where personal compact discs (CDs) and DVDs were stored in a showcase to admire and choose at will, consumers now are left with the knowledge of debits and/or credits where movie “plays” are considered the currency, and such systems do not provide anything with a label on it, or which can be held or organized into a collection to impress friends. Instead, consumers can only query a service that has their history of purchases stored in their database and optionally print this list to satisfy their need to know (and see) their account status.

Some important questions to ask in this time of enormous disruption in the video distribution market are as follows. First, is there still a market opportunity for physical media distribution that is not necessarily obvious to the new disruptors? Do people still like to shop for their content in retail facilities that allow them to mingle, weigh all options and ultimately purchase or rent the title of their choice? Will the absence of this “shopping” paradigm limit the success of new media delivery moving forward?

The answers to these questions are all emphatically, yes. It is not the casting-off of the hugely successful retail models for the new theoretical models that will spell ultimate market success. More it is the embracing of the best aspects of all models in order to provide consumers with the best possible choice, immediacy, and mobility possible. Therefore, the video shops with their rental/purchase models continue to be important as the first decade of the 21st century comes to a close.

For the past decade, the physical media vendors have been easy targets for the people looking to exploit opportunities in new media distribution. Consumers harbor ill feelings about paying late fees. They also become disappointed when they learn the title of their choice is out-of-stock. It's curious that the new media evangelists say little when it comes time to critique the aspect of shopping in a retail facility where a consumer can see walls filled with the titles just out of the theaters. This may be due to the fact that people continue to enjoy going to the neighborhood video shop and there is more enjoyment from this aspect of the experience than there is detriment. It was recently noted that establishments like Starbucks are becoming behemoths because people want and need a place to “hang out”. The video shop likewise provides this opportunity within a very pleasant atmosphere and where the ultimate purchase price is still quite reasonable.

We also know from numerous behavioral studies that people like to spend time in well adorned establishments. They also like to buy. Videos are also one of the largest single markets on earth. Therefore, the two major points of criticism are almost always leveled at the problems associated with:

Late Fees

Limited Inventory (due to the overwhelming popularity of certain titles).

Even if many of the new media distribution models tend to disrupt the older and more established models for physical media distribution, there are still enormous advantages to physical distribution. For example, the release window for physical media product from major studios is much closer to the theatrical release of the same media than the newer distribution models. For example, a DVD may be available in the video shops within a few months of the theatrical release where a Video-On-Demand (VOD) offering from a Pay-TV operator may be two to three times longer. In some cases, movie and television products are released to DVD immediately. Although certain models of high definition distribution may cause additional disruption for the video shops, they stand to enjoy the best release windows for the largest possible audience of all media delivery opportunities after theatrical. Video shops may also enjoy protection from the major studios.

In recent years, the revenues generated from physical distribution have surpassed the revenues generated from the theaters. In fact, physical media sales are the largest category of sales to the largest media companies on earth. These large media companies do not wish to see disruption so fast and furious that it causes them financial losses. Rather, the large media companies want to continue to experiment with new media models and make fine-tune-adjustments to the release windows until they are assured of keeping revenues and distributors happy (for the most part).

Video Home System (VHS) machines and DVD players combined have achieved a state of global ubiquity. The new media distribution models, in contrast, require new equipment (in some cases), education, training, and other systems that yield an excellent experience for the end consumer. It may take many years and a huge investment to displace the ubiquity of the DVD player (not to mention the VHS player).

Current day physical media distribution is also well suited for the largest possible population of people. The new technologies are often adopted by the youngest audience while the older generation tends to stick with things they know and understand. The older generation has already embraced VHS and DVD technologies. It is a stretch to see large numbers of these older people buying mobile video players (for example).

The last advantage to mention is brought about by laws in the US and other countries that provide protection mechanisms to people who buy physical goods. It is well known that a consumer who buys a physical item has the right to loan, re-sell, destroy, gift, bequeath, or otherwise handle as any other piece of physical property. By virtue of these laws, video rental shops were able to leverage themselves into business (by renting the physical units they purchased). With the new models of media delivery, the agreements between the consumers and the content owners are about to change. The content owners may insist on “license” models in place of “sale” models. A consumer may purchase a movie “play” rather than the physical copy of the movie. This licensed “play” is likely to have greater restrictions than the physical unit sold to a consumer. Therefore, video shops selling physical units to consumers (as they have done so for decades) may offer consumers the greatest degree of flexibility when compared to the other new media offerings.

The world of new media is currently bracing for the new paradigm of high definition physical media, such as Blu-Ray and High Definition on DVD (HD-DVD). Along with this new paradigm come two new promises. One promise is to the consumer and one promise is to the content owner as follows:

The consumer sees high definition movie and television product with the best possible resolution (short of digital cinema)

The content owners enjoy an unprecedented level of security as the encryption and watermarking schemes on these discs may be unparalleled.

The results of this new “early release window”, high-definition experience may send millions of consumers to the video shops for the next few years. In addition, back catalog titles that are offered in full 1080p (High-Definition) may also fly off the shelves in the video shops around the world.

In recent years, new Media-By-Mail services have sprung up that offer consumers the ability to select their titles and allow them to arrive by way of the postal carriers (or possibly overnight carriers). One such popular service offering is NetFlix. After selecting titles over the web, consumers can receive these new titles by mail within a few days. Any older titles can then be returned by way of a self-addressed mailing container provided by NetFlix. All charges are placed on the consumer's credit card.

Although such Media-By-Mail services may experience some levels of success in today's market, it is assumed that they are limited to consumers who don't mind waiting for at least a few days.

Another model that is certain to be popular as the decade progresses is the Electronic Sell Through model or EST. This model allows consumers to download their media from a Set-Top-Box or Personal Computer (PC) in order for them to burn and label their own disc. Such a model may be an excellent way to obtain the media with relative ease, however, the release windows for major film and television releases may not be favorable (for a long time to come), and these media files may be licensed to the consumer, so that the consumer has significantly more restrictions placed on their EST media.

One of the more recent developments in the area of home entertainment is the home media center. Both consumer electronic and information technology vendors have been working diligently to craft their strategies, business models, and products moving into the end of this decade. The well known Microsoft Corporation from Redmond, Wash. has had a version of its home media center software system running and available for a while. Other companies around the world are also preparing to introduce their own expressions for home media centers in order to provide consumers with the selection, features, benefits, and pricing structures designed to offer a wide variety of choice.

### SUMMARY

Embodiments described herein provide for a media distribution system and method which links local video shops to user entertainment media servers to facilitate selection and physical distribution of titles to consumers.

According to one aspect, a method of connecting consumer entertainment media servers such as home media centers, viewing devices such as set top boxes, personal computers, mobile devices, other home network appliances, and the like to one or more local video shop inventory lists is provided, which comprises receiving and storing information on inventory available at one or more local video shops in a predetermined geographical area at a video shop data center associated with a selected group of consumer entertainment media servers or devices for connection with the entertainment media devices over a network, creating a user interface for consumers or video shop service subscribers located within the predetermined area, the user interface displaying the stored local video shop inventory information, connecting the video shop data center to a selected entertainment media device, providing the user interface to the selected entertainment media device, receiving requests from consumers for one or more items in the inventory list and forwarding the requests to the appropriate video shops.

In one embodiment, consumers or subscribers to the service may order videos, games, music, or other entertainment media for rental or purchase through the user interface at their entertainment media device, and may arrange to pick up selections at the video shop carrying such items, or alternatively for home delivery. The user interface may also include the ability to view trailers before making a selection. The video shop service through the video shop data center may be directed to any type of entertainment media device or user device capable of playing entertainment media, including home media centers linked to various user devices, other home networking appliances, or individual user devices such as set top boxes, personal computers, mobile devices such as personal digital assistants, portable media players, and mobile phones, and automobile GPS systems.

Instead of a video shop data center linked to several local video shops, a dedicated video shop may offer the service to its own customers with no outside hosting assistance. In another embodiment, a dedicated video shop acts as the video shop data center and offers services to its own customers and other video shops as well (therefore, acting as the data center). The method may be embodied in a web portal model where all of the functions and features are offered over the Internet. A web-based application service provider (ASP) service may offer these capabilities to video shops in a large region, and may also offer consumers visibility into the discrete video shops in the target geographical area. Other potential models may be used to yield the same or a similar result.

According to another aspect, a system for connecting entertainment media servers to local video shop inventories is provided which comprises a video shop data center linked to at least one local video shop in a selected geographical area, the data center having a data base or data storage module which receives and stores information on the video shop inventory, a communication module which connects the video shop data center to an entertainment media device associated with a user, and a user interface module which displays a user interface listing the inventory available at the video shop and has user inputs for ordering entertainment media from the local video shop.

The communication module may be provided as an executable software code on the home media center or device (if the executable code is not already pre-loaded). By use of an external storage device such as a universal serial bus (USB) dongle or the like, the executable code can be loaded on to a home media center. Alternatively, the home media center may simply download the executable code from the Web. Such an executable software program may be written in such a way as to co-exist in an environment with other objects, services, and still other operating system-level operations that run concurrently. The executable software code may allow for the additional aggregation of valuable information (about video shop inventory, offerings, and promotions) rather than the exclusion of one or more of these services.

Once the video shop “Object” or service is loaded on to the home media center and properly installed, it attempts to contact the video shop data center in order to log-on and create an active account. Such a log-on procedure can be performed manually or in an automated fashion. The account is then created and verified by the video shop data center systems and the consumer may then engage in valuable and enjoyable two-way communication with the video shop data center and the individual video shops.

This physical media distribution system and method provides a shopping experience that is crafted to work with all of the important media delivery mechanisms envisioned for the near future.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating a high level overview of a prior art home media distribution network;

FIG. 2 is a schematic block diagram of one embodiment of a video shop media distribution system;

FIG. 3 is an example of a user interface for the video shop media distribution system of FIG. 1;

FIG. 4 is an example of another display page of the user interface illustrating how a user can search video shop inventory and order items from the inventory in the video shop distribution system;

FIG. 5 is a block diagram illustrating a modification of the video shop distribution system of FIG. 2 where the video shop data center is connected directly to a user device such as a set top box rather than to a home media center;

FIG. 6 is a schematic block diagram illustrating possible methods of loading a video shop communication interface module or executable software code or object on to a home media center or other user device;

FIG. 7 is a schematic block diagram illustrating a method of capturing information on titles purchased or rented by a user of the video shop distribution service;

FIG. 8 is a flow diagram illustrating a method of connecting users to local video shops to obtain information on available inventory and to rent or purchase titles for pick up or delivery; and

FIG. 9 is a schematic block diagram illustrating another embodiment of a video shop distribution system in which the video shop data center is linked to a social network.

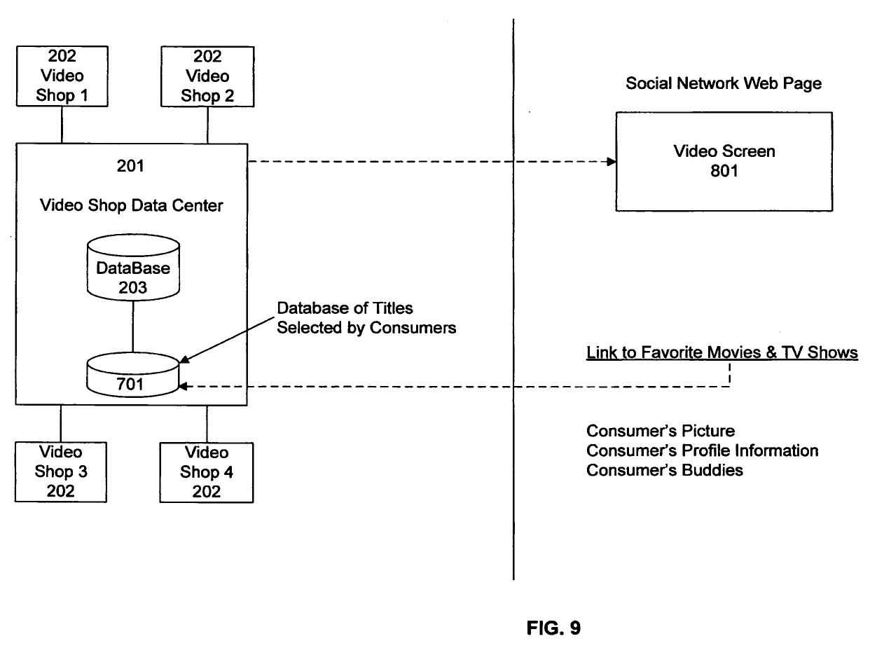

### DETAILED DESCRIPTION

Certain embodiments as disclosed herein provide for connecting home media centers or other consumer media servers to local video shops in a predetermined geographical area in order to provide consumers with visibility into the video shop inventories and promotions so that they can select media titles for pick up or delivery.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

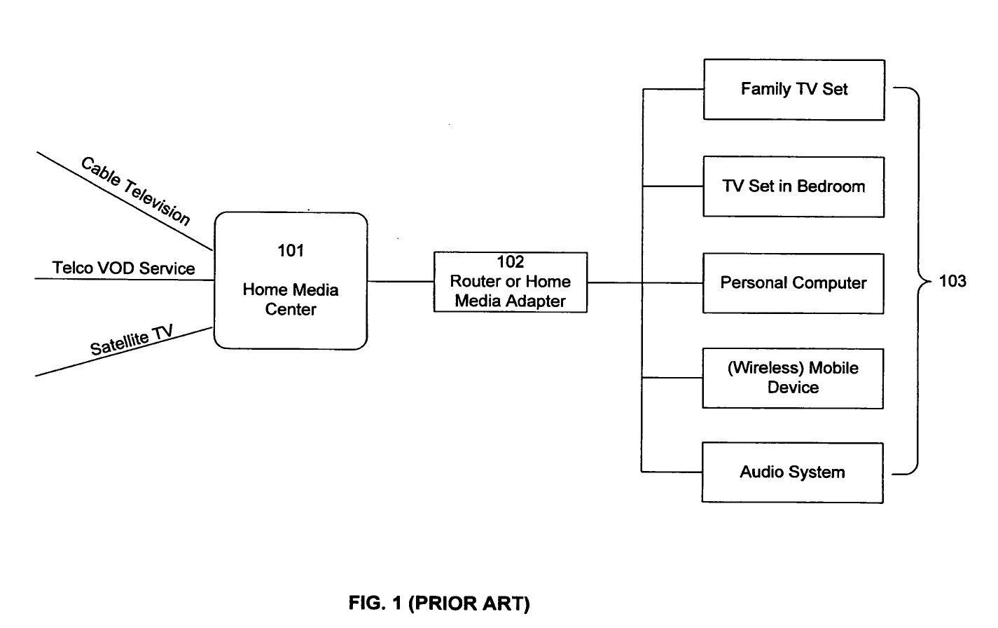

FIG. 1 illustrates a prior art home entertainment system including a media server comprising a home media center 101, which is one of the more recent developments in the area of home entertainment. Both consumer electronic and information technology vendors have been working diligently to craft their strategies, business models, and products moving into the end of this decade. The well known Microsoft Corporation from Redmond, Wash. has had a version of its home media center software system running and available for a while. Other companies around the world are also preparing to introduce their own expressions for home media centers to provide consumers with the selection, features, benefits, and pricing structures designed to offer a wide variety of choice.

The home media center is built to address two different problems as follows:

### 1. Organize and control the various sources of in-coming content

### 2. Direct the various signals (digital or analog) to the desired playback devices

FIG. 1 describes how three different sources of media are aggregated for the ultimate benefit and convenience of the consumer. The home media center 101 is built to capture signals from media sources such as cable television, telephone company (Telco) video on demand (VOD) service, satellite television, and the like, so they may be forwarded on to other client devices in the home (or office). These signals may alternatively be saved to longer term storage mechanisms and appropriately filed into database systems so consumers can query lists of available selections and play them at will. In FIG. 1, a home router 102 or media adapter is used to pass the signals on to the intended client devices 103 (using fixed line or wireless methods).

Each of the client devices 103 in the home or office environment has a connection to the home media center 101 by way of the router 102. These devices may include one or more television (TV) sets, personal computers, audio systems, mobile devices, and the like. Consumers see a user interface that is presented to them by way of the home media center 101. The home media center offers the consumer as many viewing options as possible (given the specifications of the home media center and the limitations of the licensing rights for the content). Some of these viewing options include (but are not limited to):

Place Shifting

Time Shifting

Organizing

Searching.

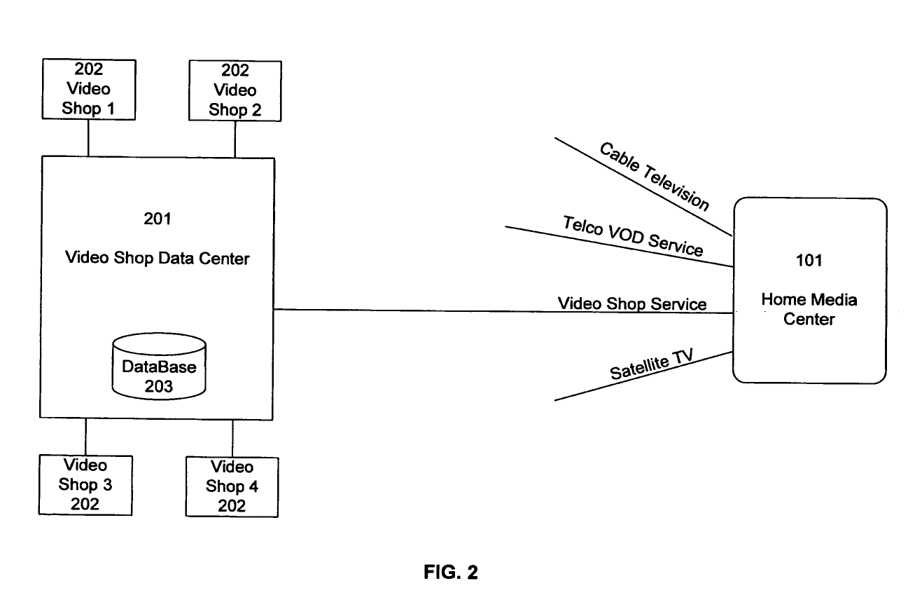

FIG. 2 illustrates one embodiment of a video shop media distribution or communication system which links a home media center 101 to one or more local video shops 202 in the same geographical area as the home or business in which an entertainment system of the type illustrated in FIG. 1 is located. As illustrated in FIG. 2, a video shop data center 201 is linked to the home media center 101 and to video shops 202 over one or more wired or wireless networks, and acts as an aggregator of physical inventory information that can be provided to the home media center 101 by way of a video shop service. The data center may alternatively be linked to other media servers associated with a consumer or video shop service subscriber.

In one embodiment, local video shops 202 in a given geographical region are associated with a data center 201 of some type to aggregate inventory and availability information for the purpose of adding this information as a content source to the consumer's home media center 101. In one embodiment, such a data center may be manned and operated by personnel dedicated to pool information from the various member video shops 202 and make this information available to consumers or subscribers to be queried, organized, and searched. Information on video shop inventory and availability may be stored on a data base 203 at the video shop data base. Trailers, promotional information, and the like may also be available via data base 203.

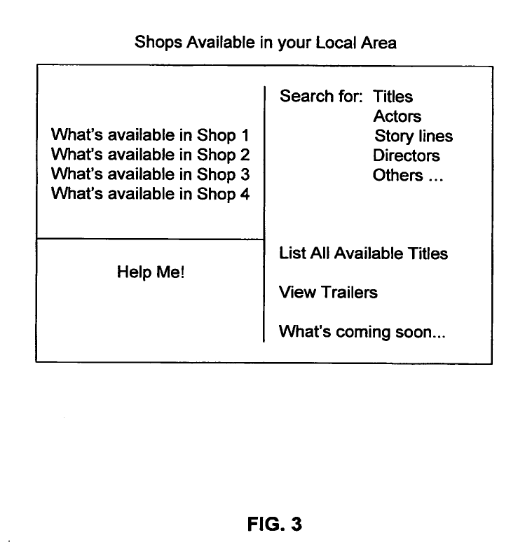

FIG. 3 illustrates the possible layout of a user interface that the video shop data center (201) could provide to consumers who subscribe to the video shop service. This user interface is intended to show the consumer information aggregated across a number of video shops. This would allow a consumer to have excellent visibility into a number of video shops in a given geographical area. As illustrated in FIG. 3, the interface provides a list of titles available in all the video shops, as well as the ability to search for titles, actors, story lines, and the like, view trailers, see previews of upcoming videos, and see which titles are currently available.

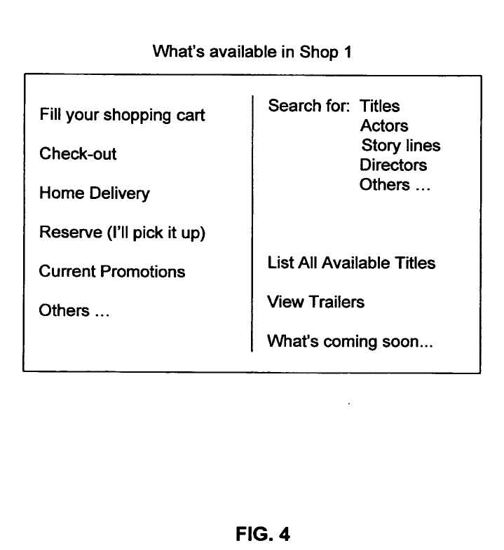

FIG. 4 illustrates how the consumer can continue to search in order to learn more about the inventory within a discrete video shop by opening a web page or user interface associated with that shop. On this page or interface, the consumer can perform a number of transactions including (but not limited to):

Ordering Videos

Ordering Games

Ordering Music

Ordering Media on Small Memory Storage Device (Flash Memory or otherwise)

Buying Food Products

Buying Memorabilia

Buying Other Products

Learning about Current Promotions

Filling a Shopping Cart

Arranging for Delivery or Pickup.

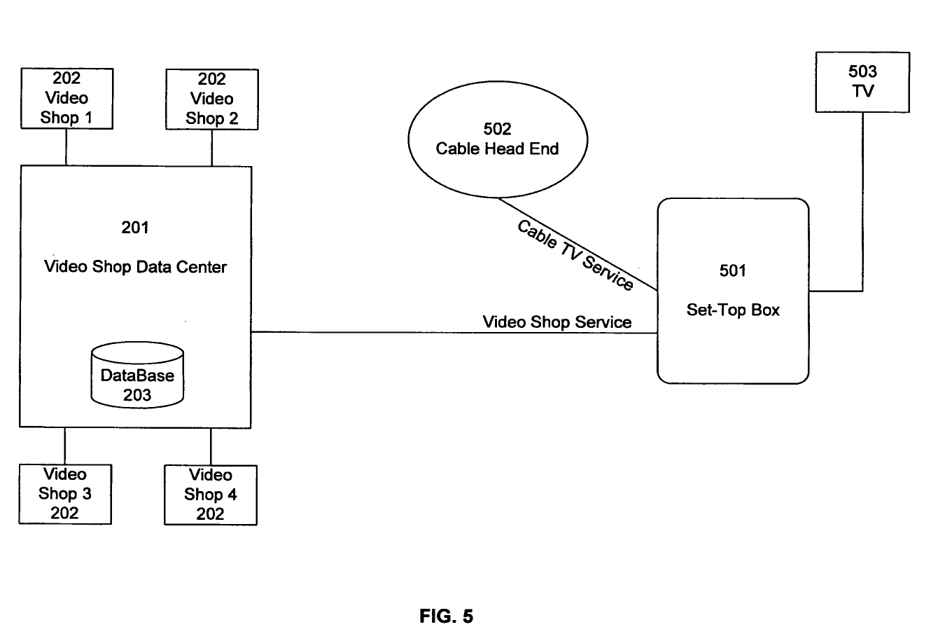

In FIG. 2, the video shop data center is linked to a home entertainment system via home media center 101 which allows the video shop user interface to be accessed from any user device 103.linked to the home media center 101. FIG. 5 describes an alternative embodiment where the video shop service is directed to an industry standard Set-Top-Box (STB) 501. Examples of such standard STBs for cable television are manufactured by Scientific Atlanta and Motorola. For other types of television services such as IPTV, examples of STBs are Amino and Wegener.

Such an example would offer a consumer at least two discrete television services, specifically a primary service offered by the consumer's television service provider, and a second service provided by the video shop data center 201 offering physical media to this same consumer.

In addition to home media centers and STBs, other media server devices can be used to access the services provided by the video shop data center 201. Some of these platforms are (but are not limited to):

PCs

Mobile Devices

Mobile Phones

Other Home Networking Appliances

Car GPS Systems (where allowed)

In order to obtain such a service, a video shop software “object” (or service) may be downloaded from the web, hard disc drive, physical media, USB Dongle, or otherwise, and the video shop software object may then be installed on the target consumer electronic or information technology device. At this point, the video shop data center becomes visible and interactive in order for the consumer to further aggregate the various options for a night's viewing opportunities.

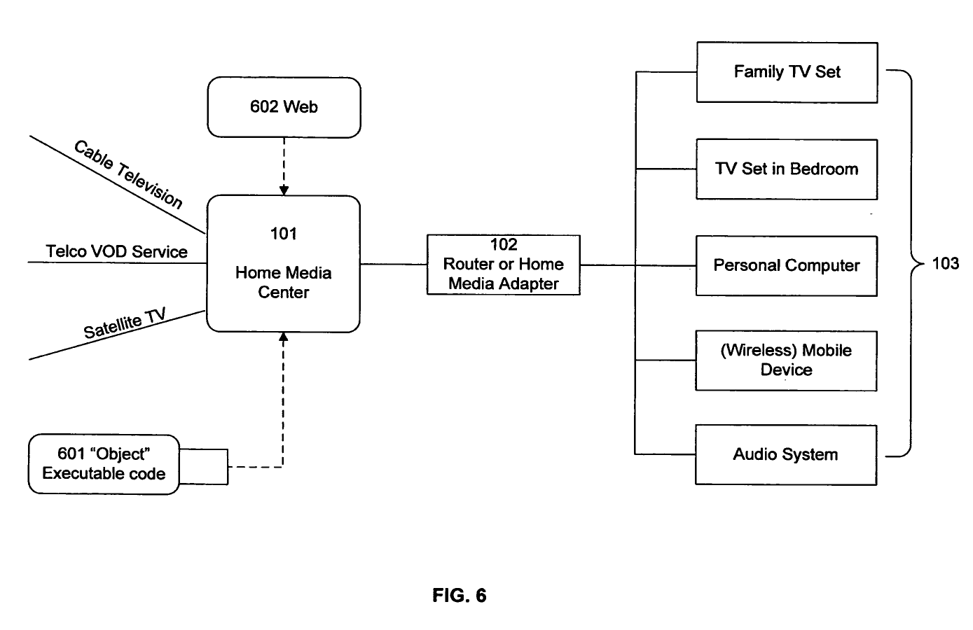

FIG. 6 describes two simple methods for loading the executable video shop software code or object on to the home media center (if the executable code is not already pre-loaded when the home media center is purchased). By use of an external storage device such as a universal serial bus (USB) dongle 601 or other, the executable code can be loaded on to the home media center. Likewise, the home media center can simply download the executable code from the Web 602. Such an executable software program is written in such a way as to co-exist in an environment with other objects, services, and still other operating system-level operations that run concurrently. The video shop software object is designed to allow for the additional aggregation of valuable information (about video shop inventory, offerings, and promotions) rather than the exclusion of one or more of these services. Although FIG. 5 illustrates loading of the executable code or video shop software object onto a home media center, it may alternatively be installed on other user devices as indicated above, such as set top boxes, PCs, mobile devices, and the like as listed above.

Once the video shop “Object” or service is loaded on to the home media center or other user device and properly installed, it then attempts to contact the video shop data center 201 in order to log-on and create an active account. Such a log-on procedure can be performed manually or in an automated fashion. The account is then created and verified by the video shop data center 201 systems and the consumer can then begin to engage in valuable and enjoyable two-way communication with the video shop data center 201 and the individual local video shops 202.

At some point in time, the local video shops or the consumers (or both) might want some profile information to become available to the video shops so they can provide more relevant and potentially rewarding promotions to these same consumers. Therefore, the consumers may be presented with a questionnaire that might help the video shops to better understand the profile and the preferences of the individual consumers in a given geographical area. Such a questionnaire could be administered on-line or by way of a printed form that is mailed to the consumer. Any such profile and preference information gathered by the video shop data center is kept confidential and secure.

In the embodiments described above, a video shop data center 201 is established to host services for a number of video shops in a given region. The data center 201 includes one or more data bases as well as one or more servers and routers or communication devices for communication with video shops and a plurality of home media centers or other user devices in the region who have signed on for the video shop service. Such a model may provide the most efficiency as costs are spread across a potentially large number of shops and the data center's resources and capabilities can be significant. There are some other potential models, however, as follows:

A dedicated video shop offers the service to its own customers with no outside hosting assistance

A dedicated video shop offers services to its own customers and other video shops as well (therefore, acting as the data center)

A Web Portal Model where all of the functions and features are offered over the Internet

A Web-Based ASP service offering these capabilities to video shops in a large region, however, can offer consumers visibility into the discrete video shops in the target geographical area.

Other potential models that yield the same or a similar result.

The video shop executable software “Object” or service can be installed in a home network, removed, activated, shared, de-activated, and further networked with other home or business devices and/or appliances. For example, such an object can be loaded into the global positioning system (GPS) of an automobile so the passengers in the car can execute the “Object”, have it create an account, so the travelers can then look to see if any video shops in driving range have a movie title of interest. Furthermore, mobile devices, PCs, set-top-boxes, and other appliances can easily load and install the “Object” in such a way as the local video shop experience becomes more enjoyable and better integrated into the everyday media enjoyment experience.

The following is a list of different content types that could be offered to the customer by way of the approach described in this application:

Movies

Television Shows

Games

Mobisodes

Pictures

Music

E-Books

Audio Books

Other electronic media types.

Other types of information can also be made available to consumers using the video shop service. Once a connection has been made between the video shop data center 201 and the consumer by way of a home media center (or otherwise), the video shop data center 201 can begin to show information and materials to the consumer. Some of this information could be designed to encourage a consumer to visit one or more of the local video shops. Other information may simply be helpful in the spirit of creating a better community living experience. Some of the information and/or materials provided by the video shop data center 201 could be (but are not limited to) the following:

Movie Trailers

Television Trailers

Messages from directors, producers, stars and otherwise

Current Inventory Information

Titles to become available soon

Purchase/Rental History Information

Promotions

Commercials

Sponsorships

Local information

Regional information

National information

World Events

Coupons

Electronic Instruction Booklet (how to use this service)

Other information that might be useful or relevant to the customer.

Electronic Program Guide Information (EPG) with suggested titles and viewing schedules

Many of the new communications technologies such as short service message (SMS), Multimedia Message Service (MMS) and others can be used by the video shop data center 201 to send relevant and timely information to the consumers within the geographical region. Such an SMS message could inform a consumer that a new title has just arrived. By way of the consumer replying to such an SMS, a request can be made to reserve a copy (by placing it into a shopping cart or otherwise) or alternatively couriered to the consumer's home or office. Such communication capabilities can further enhance the consumer's experience with added mobility and more information exchange.

Once such a system as described above is fully operational, then multiple walled garden applications can be offered as well. Examples of walled garden applications can be (but are not limited to) the following:

Weather Reports

Breaking News Reports

Stock Quotes

Airline Reservations

Restaurant Reservations

Order Food to be delivered

Celebrity Updates.

Another popular sales technique that can be used as a compliment to the system described above is the filling of a consumer's shopping cart based on relevant information previously collected from the same consumer. There are a few options that can be provided to the consumer as follows:

Automatically fill the shopping cart

Don't fill the shopping cart, however make relevant suggestions

Don't do anything.

An alternative embodiment is to allow a Pay-TV service operator to become involved in this media offering, i.e. a pay TV service operator also offers the link to local video shop offerings. Some of the things a Pay-TV service operator could do are as follows:

Provide the executable software code (“Object” or Service) that can be installed into the home media center 101

Operate the video shop data center 201

Provide the executable software code and operate the video shop data center functions and services.

Although these services may be viewed as being competitive with the offerings from the Pay-TV service operator, there could be some synergies as well. For example, the Pay-TV service operator may be the owner of the video shops in a given geographical area. Or, a revenue sharing relationship may be arranged. Another possibility is the Pay-TV service operator may not profit from the experience directly, however, they receive good will from the community by providing a valuable service.

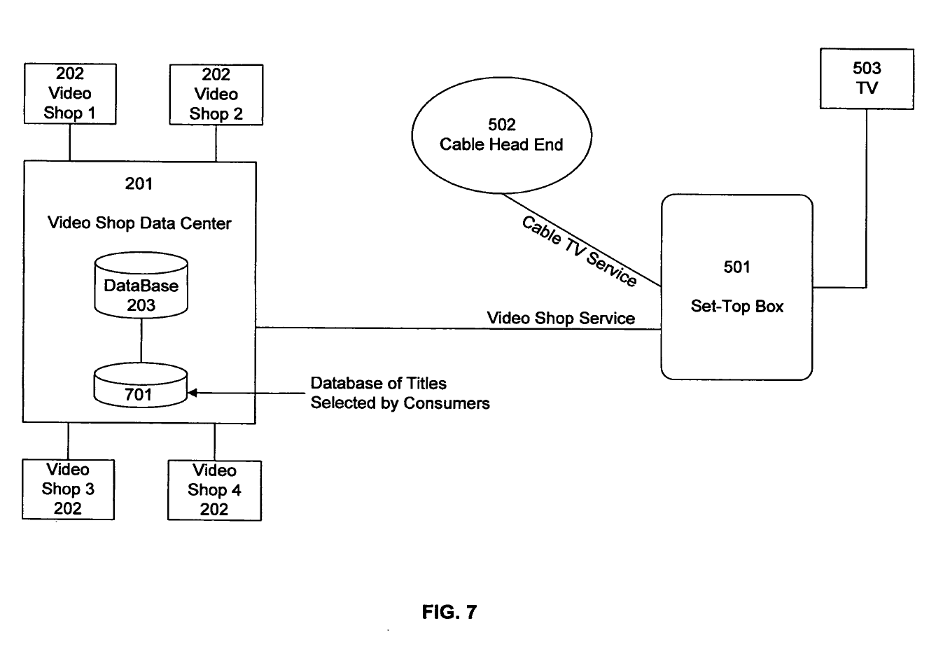

As illustrated in FIG. 7, the video shop data center in one embodiment may maintain a database 701 with all of the subscribing consumers' title-level information. Such a database captures information for titles either purchased or rented for potentially the entire history of the consumer's experience with the video shop. FIG. 7 illustrates how such a database of title specific information 701 can be located within the video shop data center 201. Such a database of title information 701 can be used for the following purposes:

A service can be offered which notifies consumers if a title has been previously purchased or rented. This may help the consumer from inadvertently ordering a title that has been previously viewed.

Consumer(s) can print or otherwise capture this title-level information at will for specific purposes that may be important or desirable to the consumer.

Buddies can be provided with access to title lists should the consumer consent. Such a list (or lists) could be helpful in community activities, events, or for other purposes.

Such a database can be maintained for still other reasons that might be important or helpful to the consumer.

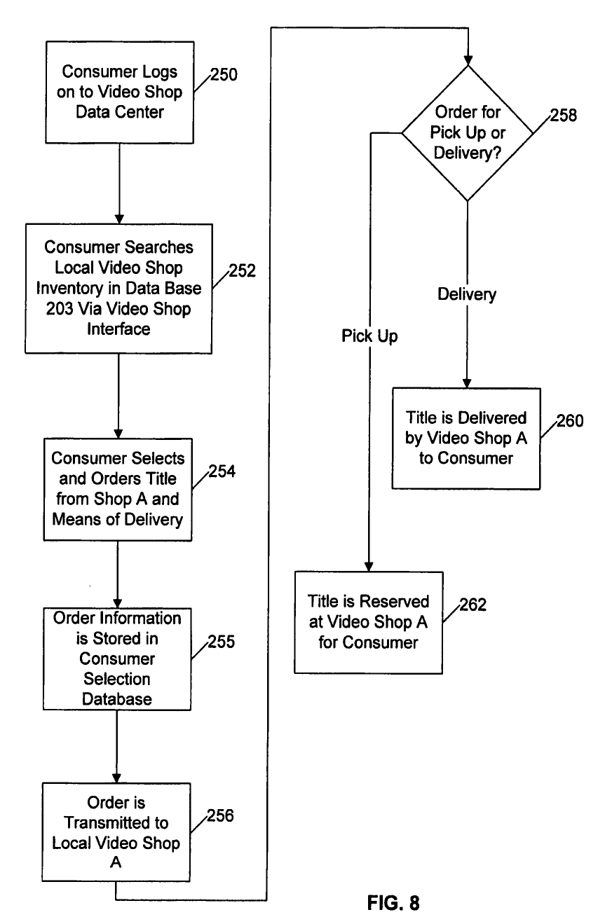

FIG. 8 is a flow diagram illustrating one embodiment of a method of using the system of FIGS. 1 to 7 to select various types of media offerings available at local video shops for pick-up or delivery. Once a consumer is signed on as a subscriber of the system with the appropriate video shop access software code loaded onto their home media center or other media server device, they may log on to the video shop data center 201 whenever they wish to view titles available at local video shops 202 within their general geographical area (step 250). The user interface of FIG. 3 is then displayed on the viewing screen of the device they are using to log on to the system, and they may either view all available titles or view the available inventories in each video shop, or search for a specific title (step 252). Once they have located one or more titles of interest, they move to an order page (FIG. 4) where they can order the selected title or titles (step 254). This step includes selecting whether they wish to pick up the title from the local video store or have it delivered to their home or office. The order information is stored at the consumer selection database 701 at the video shop data center (step 255), and is also forwarded to the video shop from which the title was selected (step 256). The video shop server then determines whether the order is for pick up or delivery (step 258). If home delivery is requested, the title is delivered to the consumer (step 260). The delivery may be by mail or messenger service, or the video shop itself may employ delivery personnel for this purpose. If pick up is selected, the title is reserved for pick up by the consumer for a predetermined time period (step 262).

An advantage of this system is that the consumer does not have to go to one or more local video shops and physically search the shelves at each video shop to try and find a title of interest, which may or may not be available at the time. Instead, without leaving their home or office, they can search the inventories of several local video shops to see what titles of interest are available. If a title of interest is found, they can immediately order the title from their home or office and either pick it up or have it delivered. This avoids the disappointment of going to a video shop and finding that all copies of a title they want have already been rented out. The system has the added advantage of allowing consumers to view previews of titles to determine whether or not they are interested in ordering them, and to receive information on video shop promotions and upcoming new titles on user devices such as home, office and mobile devices, without going to the video shop itself.

In one embodiment, the video shop content distribution or connection system can further be used to manage a points-based system that is designed to reward a consumer's loyalty, involvement, and frequent usage. Examples of such pre-existing points-based systems are frequent flyer miles and club/honor points such as you would find in the hospitality industry. Once tallied, these points can either be automatically applied to future purchases (once a target number of points is achieved), or the consumer can decide when and how to use these points at will. Furthermore, these points can be linked to an affinity card (plastic card with or without a magnetic strip), an ID Number, a USB Dongle, or any other external device or mechanism in order to link further actions or events back to the consumer's video shop account. Such a linkage of the external device (such as an affinity card) to a consumer's actions allows the video shop to engage in cross-promotional activities and other activities that might otherwise be difficult to achieve. An example is as follows: Consumers are informed that a cross-promotional event is taking place with a well-known national provider of soft drinks. The consumers are instructed to arrive at a certain location and then present their affinity card (or other similar device or mechanism). Once the affinity card is accepted and scanned, the following can take place:

### 1. The consumer receives a significant number of new “points” for participating

### 2. The cross-promotion partner is informed of the video shop's effectiveness in the program

### 3. The consumer can then be contacted after the event for some additional promotions, rewards, or entitlements.

This is only an example of the types of programs that can be arranged by developing and managing such a points-based system.

As high-speed, two-way connectivity becomes more prevalent, people are shown to display more of an appetite for virtual interpersonal connections. Sometimes these interpersonal connections are called “Communities”. Communities as such are designed to cater to people with specific needs and desires and allow them to “flock together” without leaving the comfort of their own homes or businesses. Examples of these communities are MySpace, YouTube, America On-Line chat rooms, and other such hosted service offerings. The term “Social Networks” is often used to describe these communities.

In one embodiment of the video shop connection system, various buddies within communities and social networks can be allowed to view video shop title lists and title selections in order to further enhance the community experience. Such title lists could form the basis of a very engaging discussion between members within the community.

For example, title lists and title selections can be provided to services (on-line or off-line) that may be able to use such information to the benefit of the consumer. For example, an on-line service may wish to introduce people who have the same taste in music videos. The following is yet another example of title-based information can be used for the benefit of a consumer:

A consumer decides to subscribe to an on-line service that keeps track of students who graduated from a certain school. This on-line service then offers to subdivide these ex-students into groups based on their preference in movies. These groups are then provided with discrete responsibilities for the upcoming class reunion (people who prefer comedies perform the entertainment, people who prefer documentaries organize the event, etc.)

Another example is a consumer may wish to provide a list of his or her favorite movies as a link to a social network such as MySpace. When a buddy navigates to such a consumer's MySpace page (or other social network), a link is provided that, when clicked, displays the title lists and title selections for that consumer. Rich media information can additionally be displayed (along with the title lists) that further enhance the buddies' experience.

In this embodiment, a consumer wishing to post a link to his or her title lists (as captured by the video shop data center 201 makes an appropriate request for such a link. The link can be delivered to the consumer in many different ways; however it may be delivered by way of email due to privacy concerns. Once the link is made available to the consumer, the consumer can post this link on virtually any web site. Once a buddy “clicks” on the link, then the video shop data center 201 acts as a host as it makes the consumer's title lists and trailers available to the buddy through an attractive web interface.

In one embodiment, the video shop data center 201 acts as much more than a simple host to title lists and some trailers for the movies and television shows found to be within this list. The video shop data center can additionally create a collage of trailers that may help to express the character of the consumer. Other techniques can be further employed that serve to help tell the story of the consumers and his or her character.

The link for a social network page with title lists operates much like YouTube operates with video clips on social network pages. The link can be freely posted on virtually any web page; however, the hosting service is responsible to stream the content. In one embodiment the hosting service is the video shop data center 201.

In this way buddies learn the types of movies the consumer enjoys in a very engaging fashion. Although these are simply examples of what the video shop data centers can offer by way of hosting these links, many new applications can be developed that further help to express the personality, desires, and the character of the consumer using this video shop-based system.

FIG. 8 illustrates one embodiment of a social network web page linked to a video shop data center 201. The social network web page displayed at the buddy's video screen 801 has a link to the consumer's movie title list in data base 701 at the video shop data center. Once this link is “clicked”, the title list is retrieved from the title database 701 and the appropriate video is streamed from the video shop data center 201 to the buddy's video screen.

In one embodiment, the consumer or subscriber has the right to make any adjustments to title selection lists as he or she sees fit. Such a consumer can freely add, delete, and edit title lists at will. In addition, consumers may have the ability to manipulate movie and/or TV trailers in order to further express themselves to their buddies and other interested parties. Such a process is sometimes called “Mashing” or creating “Mashups”. Therefore, a buddy “clicking” on a link to title selections may see results that have been carefully edited to create a predictable outcome on the video screen.

In so much as the video shop data center collects movie & TV title lists and title selection lists from a population of consumers, this data can be aggregated and appropriately prepared for a number of purposes as follows:

Select possible dating partners

Select friends

Provide to potential advertisers

Analyze for studios and other content creators

Analyze for content distribution partners

Analyze a discrete geographic region

Other valuable applications for such aggregated information.

In one embodiment of the system described above, the parents or guardians within a family can establish “parental control” settings for the titles that are either purchased or rented by another family member. For example, if a child attempts to either rent or purchase a title that has a rating determined to be unacceptable by a parent, then the request made by the child is denied.

Such a denial can be made if the child is making the request on-line, or the denial can be made when the child attempts to pick-up the title from the video shop, so the child is not able to view unacceptable content as provided by any of the branches of the video shop's franchise.

One or more parents or guardians can either establish the parental control settings on-line, or these settings can be established while visiting the video shop itself. In some cases, secret passwords, codes, affinity cards, or other external devices (i.e. USB Dongles) can be used to verify the parent is authentic and not a child (or otherwise) pretending to be a parent. Other methods can also be used by the video shop to establish the “appropriateness parameters” for each family member and the best ways to protect children from inappropriate content viewing.

In one embodiment, the video shop connection or distribution system as described may also offer a pre-loaded CD and/or DVD containing a huge library of the following:

New movie trailers

Older movie trailers

New television trailers

Older television trailers

Movie posters

Television posters

Movie out-takes

Television out-takes

Interviews with stars

News about stars

Gossip about stars

Other potentially interesting content for people interested in movies and television shows.

Such a CD and/or DVD can be loaded on to a home media server or used within a physical disc reader. Once such a disc is available to consumers, they can search for numerous criteria in order to view the content material that has been pre-loaded on to the disc or view a collage of content that might have some entertainment value or other.

Updated CDs and/or DVDs can be periodically mailed or otherwise transferred to consumers. Such a periodic update for consumers can be part of a subscription service, or may simply be a courtesy offering. One method of transferring the updates to the consumer may be via a download over the Internet.

The system and method described above for connecting entertainment media servers or user devices to local video shops in a predetermined geographical area provides consumers with visibility into the shops' inventories from their home or office in a convenient manner and provides enhanced ability for media selections.

Those of skill will appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method of connecting consumer entertainment media servers to local video shop inventories, comprising:
receiving title information at a video shop data center, the title information comprising inventory available in at least one local video shop located in a predetermined geographical area;
storing the title information in an inventory data base at the video shop data center;
receiving a video shop service request from a media server associated with a consumer within the predetermined geographical area;
providing a user interface to the media server, the user interface providing a link to the stored inventory of title information;
receiving an order for at least one title from the media server; and
forwarding the order to the local video shop.

2. The method of claim 1, wherein the title information includes titles selected from the group consisting of videos, games, electronic books and music.

3. The method of claim 1, further comprising physically delivering the title to the requesting consumer.

4. The method of claim 1, further comprising reserving the title for pick up by the consumer at the local video shop.

5. The method of claim 1, further comprising storing lists of titles previously ordered by a consumer at the video shop data center.

6. The method of claim 5, further comprising comparing new orders from a consumer with the stored list of previously ordered titles, and notifying the consumer if the same title was previously ordered.

7. The method of claim 1, further comprising receiving and storing title information of inventories available at a plurality of local video shops in the geographical area, the user interface comprising links to inventories available at the plurality of local video shops, whereby the user can order a title from any selected one of the plurality of local video shops, and forwarding the order to the selected local video shop.

8. The method of claim 1, wherein the video shop data center is located at the local video shop.

9. The method of claim 1, further comprising receiving search information from the consumer, searching for titles associated with the search information in the stored inventory, and providing the results of the search to the consumer, the search results comprising title, local video shop, and title availability information.

10. The method of claim 1, wherein the media server comprises a home media center linked to a plurality of consumer media player devices.

11. The method of claim 1, wherein the media server is a consumer media device selected from the group consisting of set top boxes, personal computers, personal media players, and mobile devices.

12. The method of claim 1, further comprising sending messages containing new title availability information to consumers with the geographical region.

13. The method of claim 1, further comprising providing the consumer with a link to a list of the consumer's favorite movies stored at the video shop data center, posting the link on a web page associated with the consumer at a selected web site, receiving a request from an associate of the consumer to view the list of favorite movies, and making the list available to the requestor.

14. The method of claim 13, wherein the web site is a social network web site.

15. A system for connecting home entertainment media servers to local video shop inventories, comprising:
a video shop data center having a communication module which links the data center to at least one local video shop in a selected geographical area;
the video shop data center having at least one title data storage module which receives and stores information on the current local video shop inventory and title availability;
a connection module which links the video shop data center to at least one media server associated with a consumer in the geographical area;
a user interface module which displays a video shop user interface on a display device associated with the media server, the video shop user interface having user inputs which allow the consumer to search for titles in the title data storage module at the video shop data center and to order selected titles; and
the video shop data center having an order processing module which forwards subscriber title orders to the local video shop.

16. The system of claim 15, wherein the communication module links the data center to a plurality of local video shops in the selected geographical area, and the title data storage module contains aggregated information on titles available at all of the linked local video shops, whereby a consumer can select and order a title from any of the linked local video shops through the video shop data center.

17. The system of claim 15, wherein the video shop data center further comprises a consumer list storage module which stores lists of titles ordered by each consumer.

18. The system of claim 15, wherein the title data storage module further contains previews for titles in the stored list which may be viewed by a consumer through the user interface.
